(19) United States
(12) Patent Application Publication
(10) Pub. No.: US 2020/0113198 A1
(43) Pub. Date: Apr. 16, 2020

(54) INTEGRAL USE OF SOLAR RADIATION FOR THE DEHYDRATION OF PLANT- AND ANIMAL-BASED FOODS

(71) Applicant: Enrique Antonio ÁLVAREZ DÍAZ, Estado de México (MX)

(72) Inventor: Enrique Antonio ÁLVAREZ DÍAZ, Estado de México (MX)

(21) Appl. No.: 16/624,279

(22) PCT Filed: Jun. 20, 2017
(86) PCT No.: PCT/MX2017/000073

§ 371 Date: Dec. 18, 2019

(30) Foreign Application Priority Data
Jun. 30, 2017 (MX) MX/A/2017/008811

(51) Int. Cl. A23B 7/02

(52) U.S. Cl. CPC A23B 7/02; A23V 2002/00

(57) ABSTRACT

The present invention is related with the treatment of vegetable and animal foods for its preservation and employment in the extraction of the active ingredients they include. More specifically it refers to the treatment of these foods with the comprehensive application of solar radiation. This comprehensive use of solar radiation in the dehydration of vegetable and animal foods is characterized fir consisting in a dehydration process that includes the following steps a) slicing of the dehydrating product into slices of 1 to 2 mm thick; b) expose the skin free surfaces of the product to the direct impact of sun beams; c) maintaining an air circulation, even if laminar in the premise to homogenize the humidity content in all of the air mass; ch) take the product to a humidity level of 5 to 10% d) pack the dehydrated product.

### FIELD OF INVENTION

The present invention is related to the treatment of vegetable and animal foods for its preservation and employment in the extraction of the active ingredients contained.

More specifically it refers to the treatment of these foods with the comprehensive application of solar radiation.

### BACKGROUND OF THE INVENTION

The food conservation technology by means of dehydration is used ever since cereals were planted in fields, and in the case of corn, the cornfield would be bent and left in the field so that with the effect of the sun, the cornfield and the cob would dry.

In the case of other cereals with small grain such as wheat, barley, rye, millet, among others, the plants were also left in the plantation so that with the effect of the sun the grains dried reaching a hydric balance with the surrounding air.

In the case of vegetables and fruits, dehydrating by leaving them in the field has its problems, since they must have a very high exposition time, due to the amount of water they contain.

In this instance it was observed the effect of a_{w} (water activity) in food conservation. A direct link was found between this parameter and the shelf life of products. Since it's this activity that determines the microbial growth and the enzyme activity proper of living products.

In the drying with hot air it's very important to take into consideration the speed of water exit from the products. If the drying its performed to quickly, the external tissues will allow a faster water exit and will form a barrier for the escape of water from internal tissues, leaving a lot of water in the interior even though the external tissues are already dried.

It's clear that in the drying by heat the relative humidity and the temperature of the air that will absorb and drag the moist are very important. It's also important whether the drying is performed with a parallel flow or counterflow. With the parallel drying the air and the product allow a very fast dry in the beginning and subsequently it becomes slower.

Notwithstanding from all the previously stated, thinking in dehydrating a strawberry, a mango or a banana, for example, by the means of hot air, or with air in ambient conditions, taking into consideration the fruit's constitution and dimensions will imply a very slow process and therefore with a form of microbial control to avoid decomposition during the time the product takes to dry.

For instance, in the drying of bananas, which is done very slowly, even with ambient air, it's necessary to burn sulfur wicks in the volume enclosed by anti-aphid meshes to prevent the proliferation of microorganisms. Thus, to obtain a product with a certain flexible consistency different from common crunchy bananas.

Logically, with the reduction of the particle's size, the drying could be done in a more efficient way since even with a syneresis its possible to separate a fare amount of water previous to the heating. However, it's important to determine how much can this size reduction of the particle can be carried out. It's possible that reaching a mashed consistency may not be adequate for some products, since fruit would lose a very important quality that will not be able to be restored, the consistency proper of the product.

Nevertheless, it's important to be clear that any unitary operation for the size reduction of a particle, expose the product's tissues to the action of the environment. When the product, fruit, vegetable or animal tissue has skin, this structure defends it from the environment and its aggressors, such as oxygen and microorganisms. However, when the products suffers an injury that eliminates the skin, then the tissues with its living quality and their water content are easy preys to their aggressors.

For example, the simple fact of cutting in half a fruit or vegetable, importantly increases the exposed surface by which microorganisms or oxygen can enter and, at least, perform the Maillard reaction, which is a non-enzymatic darkening. But there can also be other type of darkening and oxidative reactions.

So, the drying must be made sufficiently fast, so the speed of the reactions does not beat it. Nevertheless, we've already spoke of the results of a fast dry.

On the other hand, if we talk of the solar drying, we may realize that the use of solar energy is only destined to absorb its thermal energy. And this thermal energy uses only one frequency spectrum from all the radiations contained in solar light.

In the Chinese patent document CN105192859 owned by Liao Zigui, it's disclosed new drying equipment for the dehydration of fruits and vegetables. This equipment includes a drying box in which an air entrance and exit are formed in the drying box. A set of hot air circulation is placed outside of the drying box. An air exit of the hot air circulation set is communicated with the entrance of air through a pipe. An air entrance of the hot air circulation set communicated with the exit of air through a pipe; a solar heating panel is placed over the hot air circulation set; A thermal resistant wire is placed in the air exit of the hot air circulation set: the solar panel of the heater is connected with the thermal resistant wire in order to provide energy for the thermal resistant wire; an intelligent controller is placed in the panel over the exterior surface of the drying box; The hot air circulation set and the solar heating panel are connected to the intelligent controller; a door of the box is placed on one of the sides of the drying box. The new drying equipment is simple in its structure and convenient to operate; The solar energy is used as a heating source for the process of drying in such way that the energy consumption of the equipment, obviously can be reduced and therefor the environmental contamination is relieved.

In the U.S. Pat. No. 430,762. H. H. Taylor discloses a dehydrator for fruits and other materials consisting in a set of shelfs placed vertically, in such way that the air may circulate between them or even through them. In the bottom part, there are some heat generators mediums, one that burns fuel and another that transforms solar energy in thermal energy heating the air that by natural convection enters through the inferior ending and exits through the superior part to penetrate in the chamber where the shelves are placed. In the case that there is no solar energy or it's insufficient, it's possible to use the hot are resulting from burning fuel by means of a burner also placed in the inferior side.

In the US patent U.S. Pat. No. 5,584,127, Sutherland, Trevor L discloses a system to dry fruits, spices, vegetables and other alike, it includes a heating compartment which has an entrance to introduce a flow of drying gas and a heating disposition to elevate the temperature of the drying gas. A drying compartment is connected and in communication with the heating compartment to contain the material that is to be dried out. An activation disposition is placed in the heating compartment to direct the heated drying gas through the heating compartment and with a drying relation to the material that is placed to be dried in the drying compartment. It's provided an scape disposition in the drying compartment to remove a portion of the exhausted drying gas and recycle another portion of the exhausted drying gas over again in the drying compartment.

In the US patent IS 4.069.593, Huang Barney K discloses a greenhouse maturing and drying structure adapted to collect energy linked to the available solar radiation and to use the associated heat, in the maturing and drying material within the greenhouse maturing and drying structure. Basically, the structure includes an exterior transparent casing and a solar energy collector casing placed within that defines a drying zone or a chamber beneath it. During the maturing and drying phases of the material in the drying area or in the drying chamber, an exterior air system is directed from the aforementioned exterior transparent storage and set collector storage where the solar energy in the form of collected heat is transferred to the passing air system. The heated air system by the means of solar energy, depending on the temperature conditions inside the drying structure with respect to the desired drying program, might be directed to an air entrance of an oven system associated with such maturing and drying structure or directed through an energy storage installation, where the energy associated with itself might be stored for its subsequent use.

In the US application 201610102910, CHEN Yilong and others disclosed a solar energy drying integrated system, that includes a solar greenhouse a solar energy storage bed, and air condenser, a moist dust collector, pipeline, valves and blowers. The solar greenhouse includes a superior side, 3 sunny sides and a shaded side, soil tables, a gas entrance and two gas outlets. The solar energy storage bed includes a superior air box, an inferior air box, several solar heat build-up tubes and a sealing chamber. Each solar heat build-up tube includes an air pipe. The air condenser includes an air entrance, an air exit, two gas chambers and a gas tube bundle.

The solar greenhouse, the solar energy storage bed, the air condenser, the moist dust collectors are connected through the pipeline. The valves and the blowers are placed in the pipeline.

The use of all of these devices, achieve the purpose of dehydrating the products that are introduced. However, they not only circumvent, but they don't take into consideration several very important aspects, on one hand they don't mention the conditioning that the products should have for a proper dehydration, it doesn't take into consideration the formation or dimensions of the product that is to be dried, nor takes into consideration that the speed of drying could be so low that the product melts before drying at a convenient humidity. This is fundamental, since its not even taken into account the quality it lends to the product for its subsequent rehydrating.

It also currently exists tomato and campaign fruit dehydration, allowing the incidence of sunlight on the products. However, for example, in Spain large amounts of salt are used for the semi-dehydration of tomatoes, which are only cut in halves and the product is not further sliced. On the other hand when it comes to deal with sweet fruits, are also processed on campaign, but there are neither sliced a lot and large amounts of sugar are employed to crystalize the fruit.

### OBJECTIVES OF THE INVENTION

One of the objectives of the present invention is to make possible a dehydration procedure which uses the radiation with all its frequency spectrum of the so-called solar light.

Another of the objectives is to achieve a process that reduces the dehydration time with the inclusion of a treatment step in the dehydrating products.

Yet another objective is to grant independence to the process in a way that even though the drying process prolong to much the product will not deteriorate prior to achieving the required humidity. Another objective is that the dehydrated product that results from the process application covered by the present description results in living tissue when rehydrating it.

Another objective is that the dehydrated product has the capacity of allowing an easy exit of the appealing chemical compounds contained in the extracellular spaces and even in the interior of the tissue cells. Furthermore, another objective is to achieve the dehydration without the intervention of an osmotic modifier, such as sugar or salt. And all those advantages and objectives will materialize from the reading of the present entire description.

### BRIEF DESCRIPTION OF THE INVENTION

In short, the present invention intakes a dehydration process consisting in the following steps a) size reduction of the product's particle to dehydrate b) set the skin free surface of the product in direct contact with the solar radiation in an environment free from insects with a constant flow of air produced by natural convection or even a forced convection by the means of a fan; c) retrieving the product when it has already reached a predetermined humidity and d) pack the product in bags of any kind of material.

In terms of the reduction of the product's particle it consists in slicing the product in wedges with a thickness among 1 or 2 mm. In order to put the skin free surface of the product in contact, there are different options, one of which consists in placing the slices in a band of pierced fabric to allow the pass of air through it. In this case the band will have a slow movement to maintain the contact with a direct solar radiation from the sun for 5 to 10 hours to the skin free surface of the product that is to be dehydrated.

Another option or preferred mode is to distribute in a single layer over framed meshes in such way that the slices will not overlap. Such meshes could be made of any kind of anti-aphid fabric, an eyelet fabric that allows the passing of air through it. These meshes will be placed in such way that the product receives the radiation.

On the other hand, it's required that you maintain an air flow so that the water dragged by the air exits the premises in order to maintain an air that continues absorbing water without reaching a dew point. For this it's sufficient to place a low capacity air extractor. Being a slow dehydration, it will also be a slow air exchange, this flow can even not be turbulent or laminar. Someone may even call it a ‘little breeze’. Normally, if you have a sufficient insolation in the place, you will also have an ambient air with a low relative humidity, and therefore it could continue to absorb humidity from the dehydrating products.

Normally, with the aforementioned conditions the temperature inside the premises where the dehydrating product lies will reach a temperature around 35′C.

The process will stop when the product has a 5% to 10% humidity, which is a lower humidity from that which cereals normally has for its preservation, namely 14%, this is due over all to the characteristics we must provide the product because of the fact that it has loss its protection tissue, that could be called skin.

As for the premises where the product will be placed, ideally it would be placed in direct contact with solar radiation, however, to keep it free of insects, or other types of flora and fauna that may affect the quality of the product, it was determined that the optimum will be to keep the premises surrounded by a fabric so-called anti-aphid which has a smaller eyelet, than those called insect screens.

With the eyelet that these fabrics has the solar radiation may enter and be in contact with the dehydrating product. It's clear that the location and orientation of the premises is very important, and it has to be such that it takes full advantage of the insolation, so throughout the premises it should be facing the sun, and the ideal for the structure configuration that will sustain the anti-aphid fabric, would be that which provides a semicircular configuration from the highest point to the ground.

It's convenient that the dehydrating product's support are as close to the ground as possible or have a mechanism that provides a movement similar to sunflowers. Reiterating that it's important that the solar radiation come into play with the skin free faces as long as possible.

### BRIEF DESCRIPTION OF THE FIGURES

FIG. 1 shows the distribution of an equipment modality to dehydrate a food product by the means of the sun, in which the product is placed in a conveyor belt.

FIG. 2 illustrates another modality in which the product is placed in the fabric's frames.

FIG. 3 illustrates a modality with covered premises for the dehydration subject to the present innovation.

FIG. 4 shows another modality of covered premises.

### INVENTION'S DETAILED DESCRIPTION

The present invention has two slopes, on the one hand it refers to a dehydration process by the means of solar radiation and on the other it refers to the installation that allows this dehydration in an efficient way, optimizing such radiation.

When we talk about the solar dehydration in most of the developments of the current state of the art, we generally speak of the transformation of radiation into heat energy. Generally, in these developments the absorption of the heat energy in solar radiation is optimized. There is a working fluid that absorbs such heat energy and subsequently this working fluid also heats the air which is in contact with the dehydrating product. Or the working fluid is directly the air that will be injected in the premises' space where the product's moist exit will be done, dehydrating it, and the absorption of such moist by the means of the surrounding air to drag it out the premises.

In this last case a solid surface is used as a receptor which will get heated with the solar radiation and subsequently releases the heat energy increasing the temperature in the working fluid.

In the present invention, both the process and the installation are designed so that besides from heat energy it's possible to take advantage of solar radiation to control the decomposition factors, as long as there are proper conditions on the humidity for these transformations.

Consequently, it's a fundamental requirement that the slicing of the product that is to be dehydrated is done as soon as possible before placing them in the band or in the trays where the product will be exposed to the impact of the solar radiation. To achieve this, one of the ways is that the slicing is done creating 1 to 2 mm wedges and immediately after its slicing the wedges will fall in the band or the trays.

Since in any dehydration it's necessary to drag the humidity from the product, avoiding for the surrounding air to reach a relative humidity of dew point, an installation requirement is that it allows the entrance and exit of air, without the need of turbulent flows, since a laminar flow is more than enough. Especially because the humidity absorption by the surrounding air is not in a very elevated rate. To achieve this, it's not necessary to place an extractor, that might be one of the modalities, it would be enough to place a fan that homogenize the air humidity throughout the space. It's proposed as a solution to cover the premises with an anti-aphid fabric, any other medium, such as glass or some sort of transparent plastic, will not cover the required conditions since some of the sun's radiations with certain frequencies will not pass that barrier.

Another fundamental aspect, mainly in the dehydration of product with a high humidity content, a volume and a product's formation with dimensions superior to 2 mm in at least one of its axis, is that it's necessary that one of the dehydration process steps is a reduction in at least one of its axis of such dimension, for which it's proposed a slicing of the product with wedges between 1 and 2 mm. And it's in this point when the critical situation is presented where it's required the action of the sun in the product to dehydrate, since the slicing exposes at least one surface, when the wedge was located in the edge of the product, and two when it's an in-between wedge. This exposure to the ambient, oxygen and other gases and microorganisms with the amount of humidity present in this surfaces, the water activity a_{w} is pretty elevated and the presence of enzymes and biochemical products provokes that the enzyme and chemical reactions as well as the microbial growth become very intense under this conditions as long as a certain humidity is not achieved in the product 5 to 10%

Due to the above one of the steps covered by the present description is the impact of the solar radiation in the product's surfaces exposed to dehydrate for at least 5 to 7 hours before the product reaches de desired humidity.

To achieve this incident towards the product it's required that the premises are nor limited by plastic, glass or any other non-transparent material, since these materials would stop some radiation with certain frequencies. Therefore, it's proposed that the premises are limited by a support as wide as possible wrapped in an anti-aphid fabric, which will allow the entrance if not of all radiation, of most of it. On the other hand as a way of allowing the detach of the slices from the band or the trays, one of the modifications includes to place a susceptor beneath the bands or trays which allows a partial dehydration from the side of the wedge that is not in direct contact with the solar radiation and this allows for the surface of the wedge not to stick to the anti-aphid fabric.

As it may be foreseen, from a certain incidence angle from the sun over the anti-aphid fabric, the radiation will not be able to pass and impact on the dehydrating product. So, it's proposed in one of the modalities for the fabric to cover the premises with a fabric support that provides it with a semi-circular formation from the highest point to the part the premises are in touch with the ground.

Besides the formation of the fabric coverage that covers the premises, something that goes without saying is the location of the premises and its orientation. The premises must be placed in an elevated site where trees or any other surrounding construction would not create a shade. And must be oriented in such way that the sides with a greater surface are facing the sun throughout the year, this is, that in a rectangular premise one of the sides is facing east and the other west.

To increase the time of solar radiation incidence, two modalities are proposed, the first in which the product is as near as possible from the ground whether in a conveyor belt or in fixed trays. The displacement speed of the belt may be very slow, but the requirement to fulfill is that the product in its exposed side is in contact with the sun for 5 to 7 hours to allow dehydration without the spoiling effect from enzymes or microorganisms.

It should be sought, at least, that during the first dehydration hours the radiation impact on both exposed surfaces (skinless), when the product consists of slices. In the case of conveyor belts this might be achieved through overlapping in both ends of the belt, the one which is upstream with its edge in the superior part of the ending of the following belt.

In the tray drying modality, this might consist in two anti-aphid fabrics with its corresponding frames, being one of them slightly smaller so that it might fit in the other and maintains the product in-between the two trays, being able to turn them exposing the exposed surfaces of the sliced product alternatively to the solar radiation impact.

The mechanism will allow to keep up with the relative movement of the sun. In one even more sophisticated modality the union of the trays to its supports will consist on a ball joint that will allow two spins, one to follow the relative displacement of the sun during the day and the other to follow the sunrise and sunset during the seasons.

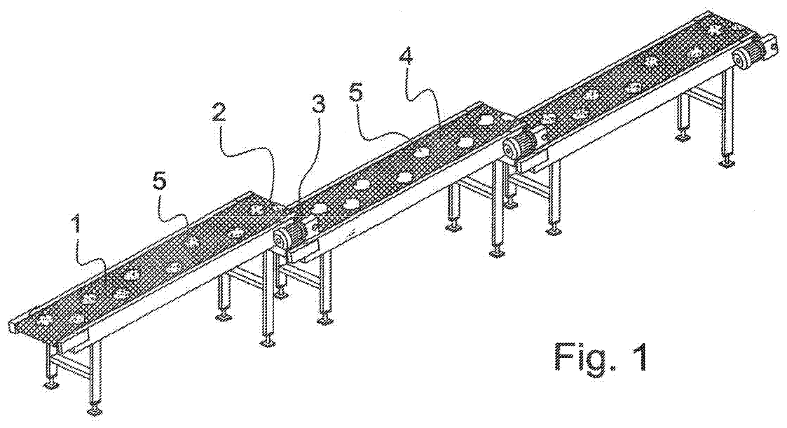

FIG. 1 shows the distribution of one equipment modality to dehydrate a food product by means of the sun, where the product is placed in a conveyor belt 1. This belt presents various modalities, one of which is continuous and the is formed by at least two segments in which the retail end of one matches, overlapping the initial edge of the following belt to allow the inversion of the exposed side of the product to the sun. It's important to mention that it's required to maintain a circulation, even if laminar of the air in the dehydration premises, with the objective of maintaining air with a homogenous humidity. In the preferred modality, in which the premises are limited by an anti-aphid fabric, it would not be needed the use of an extractor or air injector in the premises. A low capacity fan would be enough, to maintain a small breeze inside the drying premise.

It must be taken into consideration for the length of the belt and its speed that the incidence time required from solar beams in the product is of 5 to 7 hours or until the product reaches a humidity of 5 to 10%. During the drying is convenient to take into consideration that at least in the beginning its required for the sunlight to impact in both sides of the product's slice that is to be dehydrated. Which is why it's seek that in the first sections of the belt there are various steps that turn the side of the product that receives the solar radiation

In FIG. 1, the retail end 2 in the belt 1 overlaps with the initial edge 3 of the belt 4 to allow the slice turning 5. The distribution of the slices supports whether in trays or in belts is such that it must take greatest advantage of space, without allowing the free circulation of the operators. In any point the use of a fan is required to provide movement, even if laminar of the air. This aids the displacement of the natural convection of the air, displacement due to the hot masses of the inferior part which by diminishing its density with temperature moves up and displaces the masses of superior air downward since they have a higher density.

On the other hand, the superior mass has a lesser amount of water since it gives it up to the exterior air through the anti-aphid fabric. And when the sun shines the air has a relatively low humidity.

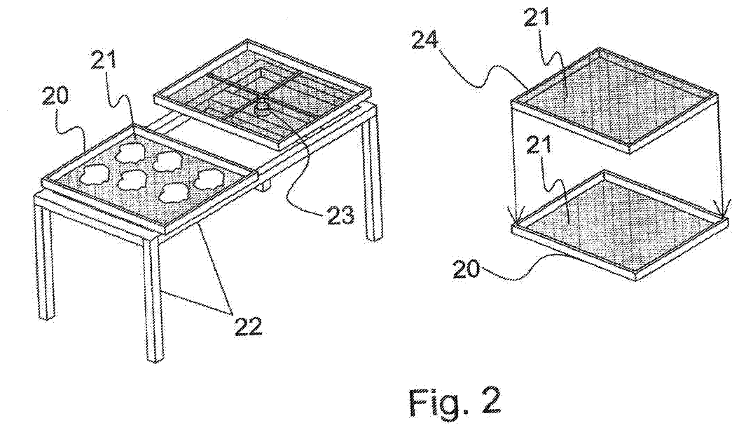

FIG. 2 shows another modality in which the product is placed in frames 20 with anti-aphid fabric 21. Having a preferred modality in which the frames are fixed in ptr's 22. Another modality has the characteristic in which the tray is fixed to a ball joint 23 that allows it with no engine to tilt the trays in order for the them to follow the relative displacement of the sun. It's also a preferred modality in which the tray is formed by two frames with the corresponding anti-aphid fabric, the frame 24 with dimensions so it might tightly enter the frame 20, in a telescopic way and that between both fabrics the product's slices are placed for dehydration, so that just by spinning the assemblage its possible to switch the sides facing the sun, without turning wedge by wedge.

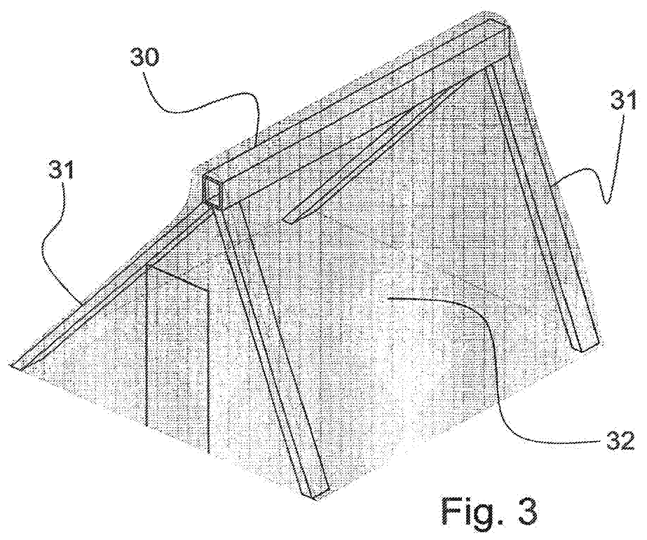

FIG. 3 shows a modality in which the premises' cover for the dehydration subject of the present invention. This is a very simple construction and it only consists in a superior crossbar 30 with a pair of inclined poles 31 on each edge forming a triangle with the vertex above. All of this is enveloped by an anti-aphid fabric 32.

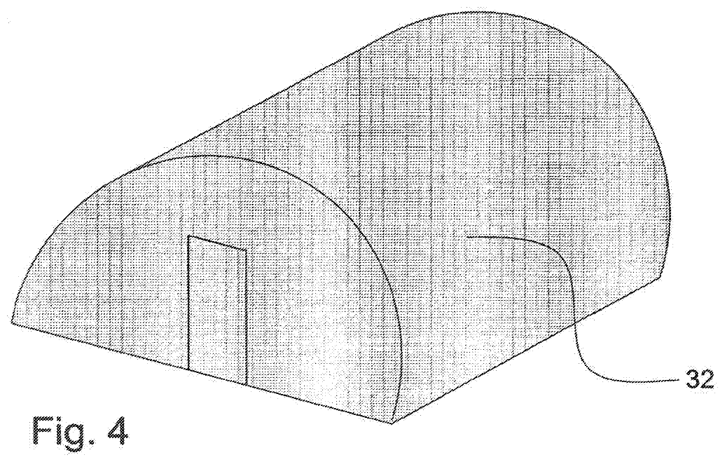

FIG. 4 shows another coverage modality for the premise. In this modality the support structure of anti-aphid fabric provides it with a semi-cylinder formation to achieve a better utilization of the solar radiation to allow throughout the relative route of the sun, the least shade over the dehydrating products. The curve on the semi-cylinder has a relation with the curve of the sun in the horizon so that the solar radiation penetrates tangentially the mesh or anti-aphid fabric 32 so that they generate a minimum shade.

This formation might be coupled with a tilt in the supports where the dehydrating product's slices are placed, and such slices will receive a maximum of solar radiation.

The invention has been sufficiently described in order for a person with average knowledge in the field to reproduce and obtain the mentioned results in the present invention. However, any skillful person in the technical field related to the present invention may be able to make undescribed modifications to the present application, but if, for the execution of those modifications in a determined structure or in its manufacturing process, it's required the matter requested in the following claims, then they should be comprehended within the scope of this invention.

Having already described the invention it's considered as an innovation and therefore claimed as property the content of the following claims:

1. The comprehensive use of the solar radiation in the dehydration of vegetable and animal foods, characterized for consisting in a dehydration process that includes the following steps a) slicing of the dehydrating product into slices of 1 to 2 mm thick; b) immediately expose the skin free surfaces of the product to the direct impact of sun beams; c) maintaining an air circulation, even if laminar in the premise to homogenize the humidity content in all of the air mass; ch) take the product to a humidity level of 5 to 10% d) pack the dehydrated product.

2. The comprehensive use of the solar radiation in the dehydration of vegetable and animal foods, as described in the previous claim, characterized furthermore because the step b) is done during 5 to 7 hours.

3. The comprehensive use of the solar radiation in the dehydration of vegetable and animal foods, as described in claims 1 and 2, characterized because the exposure of the bare surfaces of the product is done alternatively.

4. The comprehensive use of the solar radiation in the dehydration of vegetable and animal foods, as described in claims 1 to 3, characterized furthermore because the air circulation is done by flowing the air to the interior of the premises where the dehydration is taking place.

5. The comprehensive use of the solar radiation in the dehydration of vegetable and animal foods, as described in claims 1 to 3, characterized furthermore because the air circulation is done by taking out the air of the premises and by natural displacement placing the air in as the result of such air exit.

6. The comprehensive use of the solar radiation in the dehydration of vegetable and animal foods, characterized because the installation used to develop this process includes a premise in which the dehydration will take place; within such premise there are slicing mediums placed for the dehydrating product that lead to supports where the sliced product receives the incidence of the solar beams and the humidity of the product is absorbed by the surrounding air and an air displacement medium in any position of the premise.

7. The comprehensive use of the solar radiation in the dehydration of vegetable and animal foods, as described in the previous claim, characterized furthermore because the premise is limited by a support wrapped in anti-aphid fabric.

8. The comprehensive use of the solar radiation in the dehydration of vegetable and animal foods, as described in the previous claim, characterized because such premise includes a support structure and an anti-aphid fabric with the shape of a semi-cylindric dome in the highest part of the premise.

9. The comprehensive use of the solar radiation in the dehydration of vegetable and animal foods, as described in the previous claim, characterized because such semi-cylindric dome extends from the highest part of the premise to the lowest part next to the ground.

10. The comprehensive use of the solar radiation in the dehydration of vegetable and animal foods, as described in claim 6, characterized furthermore because the support is selected amongst anti-aphid fabric trays or ant-aphid belts or conveyor belts.
